(19) United States
(12) Patent Application Publication
(10) Pub. No.: US 2008/0128264 A1
(43) Pub. Date: Jun. 5, 2008

(54) THREE-PHASE EXTRACTIVE DISTILLATION WITH MULTIPLE COLUMNS CONNECTED IN SERIES

(76) Inventors: KUANG YEU WU, PLANO, TX (US); ADAM T. LEE, DALLAS, TX (US); TZONG-BIN LIN, CHIAYI CITY (TW); HUNG-CHUNG SHEN, Chiayi City (TW)

Correspondence Address: LAW OFFICE OF SPENCER CHEN, 38 DOCKSIDE CIR, REDWOOD CITY, CA, 94065-1770, US

(21) Appl. No.: 11/836,108

(22) Filed: Aug. 8, 2007

Related U.S. Application Data
(60) Provisional application No. 60/836,897, filed on Aug. 9, 2006.

(51) Int. Cl. B01D 3/40; B01D 3/26; B01D 3/34; B01D 3/36

(52) U.S. Cl. 203/52; 202/158; 202/161; 203/84; 203/50; 203/69; 203/53

(57) ABSTRACT

A novel method for connecting multiple existing columns which are retrofitted into vapor-liquid contacting devices with trays or packings suitable for the operation of a three-phase (vapor-liquid-liquid) extractive distillation column for aromatics recovery. The retrofitted columns are connected by a vapor transfer line to transfer the vapor phase from the top of the lower column to the bottom of the upper column, and by a liquid transfer line to transfer the liquid phase from the bottom of the upper column to the top of the lower column of the three-phase extractive distillation column. One improvement is the feeding of the ascending vapor from the top of the lower column to below the liquid level in the bottom of the upper column as the aeration/mixing driving force and/or in combination of the installation of a jet mixer to prevent phase separation, which is deemed to occur at the bottom of the upper column, wherein a bulk quantity of liquid is maintained without mixing in order to provide the hydraulic head for the bottom liquid transfer pump. The jet mixer, if installed, uses the bottom liquid from the upper column or the extractive solvent feed as the jetting liquid to provide the necessary mixing to homogenize and disperse the two liquid phases in the bottom of the upper column. Experimental data is disclosed for verifying the existence of two liquid phases in the three-phase extractive distillation column.

### BACKGROUND OF THE INVENTION

1. Field of the Invention

The present invention relates to a system and method for processing a three-phase distillate in a distillation column for chemical recovery. The invention further relates to transferring vapor and liquid between columns in series.

2. Related Art

Distillation is a method of separation of substances based on differences in their volatilities. However, the technique is now widely used for a variety of liquids in the chemical industry and in the production of petroleum products, among other fields. The device used in basic distillation is referred to as a still and consists at a minimum of a reboiler or pot in which the source material is heated, a condenser in which the heated vapor is cooled back to the liquid state, and a receiver in which the concentrated or purified liquid is collected.

The first basic distillation method is where the vapors which result from heating the source material may consist of two liquids with significantly different boiling points. Thus, the vapor that is given off is a greater component of in the vast majority of one of the liquids, which is then condensed and collected after the separation.

The second method distillation method is fractional distillation. Fractional distillation is more effective at separating liquids with similar boiling points. This method is the most widely used in industrial applications of continuous, steady-state systems such as in petroleum refineries, petrochemical plants and natural gas processing plants.

Industrial distillation typically refers to processes which are performed in large, vertical cylindrical columns known as distillation towers or distillation columns with diameters ranging from about 65 centimeters to 6 meters and heights ranging from about 6 meters to 60 meters or more. When the process feed has a diverse composition, for example, in the distillation of crude oil, liquid outlets at different intervals going up the column allow for the withdrawal of different fractions or products having different boiling points or boiling ranges. The “lightest” products, with the lowest boiling points, are pulled from the top of the columns and the “heaviest” products (those with the highest boiling point) exit from the bottom of the column. Large-scale industrial towers also use reflux to achieve a more complete separation of products.

Design and operation of a distillation column depends on the feed and desired products. Given a simple, binary component feed, analytical methods such as the McCabe-Thiele method can be used. For a multi-component feed, simulation models are used both for design and operation. Moreover, the efficiencies of the vapor-liquid contact devices, typically plates or trays, used in distillation columns are typically lower than that of a theoretical 100% efficient equilibrium stage. Hence, a distillation column needs more plates than the number of theoretical vapor-liquid equilibrium stages.

In industrial chemical processing systems, azeotropic distillation usually refers to adding another component to a feed mixture to generate a new lower-boiling azeotrope that is heterogeneous. The azeotrope needs to be “broken” in order to refine further which done by either adding a material separation agent to change the molecular interactions and eliminate the azeotrope. The agent is then removed by further processing.

Another method is pressure swing distillation which relies on the fact that an azeotrope is pressure dependent. It also depends on the known properties of an azeotrope which is not a range of concentrations that can not be distilled, but the point at which activity coefficients are crossing one another and an azeotrope may be distilled out by altering the pressure in the system.

In extractive distillation, the distillation occurs in the presence of a solvent. The solvent or entrainer is typically a miscible, high boiling and relatively non-volatile component. No azeotrope will form with the other components in the feed mixture. The solvent used for mixtures typically has a lower value of relative volatility, nearing unity. Mixtures having a low relative volatility can not be separated by simple distillation because the volatility of both the components in the mixture is nearly the same causing them to evaporate at nearly the same temperature to a similar extent, thus reducing the chances of separating either by condensation.

The method of extractive distillation uses a solvent or entrainer, which is generally nonvolatile, has a high boiling point and is miscible with the mixture but does not form an azeotropic mixture. The solvent interacts differently with the components of the mixture to cause their relative volatilities to change. This causes the mixture to be separated through distillation. The component with the greater volatility separates out as the top product. The bottom product consists of a mixture of the solvent and the other component, which can be separated easily because the solvent does not form an azeotrope with it. The two can be separated by any of the methods available.

A very essential part of this type of distillation is the selection of the solvent, which assists in the separation of the two components. The solvent should alter the relative volatility significantly at an economical cost by lowering the quantity, being a lower cost solvent or have a high availability. Other ideal properties of the solvent are that it is easily separated from the bottom product and will not react chemically with the components or mixture and will not cause corrosion in the equipment either.

Three phases (vapor-liquid-liquid) exist in azeotropic distillation systems and methods where the entrainer has limited to statistically no solubility for at least one key component in the feed mixture. For example, one of the preferred embodiments of U.S. Pat. No. 4,382,843 to Black discloses the feeding of ethanol and water mixture with near azeotropic composition to an azeotropic distillation column for producing dry ethanol as the bottom product. N-pentane or a heart cut gasoline (HCG), which included isopentane, pentane, cyclopentane, 2,2-dimethylbutane, 2,3-dimethylbutane, 2-methylpentane, 3-methylpentane and n-hexane was used as the preferred entrainer. The three-phase situation exists and is easily identifiable in this azeotropic distillation column, since water, one of the key components, has negligible solubility in n-pentane or HCG.

Three phases may also occur in extractive distillation, if the extractive solvent has very limited solubility of the less polar components in the feed mixture. For example, U.S. Pat. No. 4,053,369 to Cines discloses a successful extractive distillation process for purifying the C₆-C₈ aromatics using sulfolane with water as the solvent, where three phases existed in the upper portion of the column. This is due to the fact that sulfolane has very limited solubility of the less polar non-aromatics, which are concentrated in the upper part of the extractive distillation column.

Existence of three phases (or two liquid phases) in a distillation column is undesirable and may create many operating problems in the column. At first, limited experimental data available in the art suggests that the column (or tray) efficiencies are quite low and highly variable in the range of 25 to 50% in the two-liquid phase region. Also, poorly mixed two liquid phases in the reboiler of a three-phase distillation column can cause cyclic evaporation of one of the liquid phases and produces a tremendous pressure drop, which could cause a great damage to the column internals. (Refer to: Repke, J.-U., Wozny, G. “A Short Story of Modeling and Operation of Three-Phase Distillation in Packed Columns,” Ind. Eng. Chem. Res. 2004, 43, 7850-7860.)

Although distillation with three phases has been the subject of continuous investigation, the wealth of knowledge still remains rather limited compared to conventional two-phase distillation, which involves just a single liquid phase. The occurrence of a second liquid phase can influence the mass transfer in a drastic manner. The current simulation methods for the three-phase system are all based on the equilibrium stage model, so their predictions on behavior of the highly non-ideal vapor-liquid-liquid (VLL) equilibrium system need to be improved for better accuracy and reliability. In fact, the existing models of the three-phase distillation cannot predict the separation efficiency accurately and anticipate of the occurring of three phases reliably. A method for determining the occurrence and stability of multi-liquid phases in ternary mixtures was discussed in a paper, entitled “A simultaneous method for Two- and Three-Liquid-Phase stability Determination,” published in AIChE Journal, vol. 50, No. 10, 2571-2582.

Further development is required for adapting this type of new correlations into the existing models for improved performance. However, difficulties arise due to the fact that the three-phase distillation system must allow for mass transfer to and from the interrelated three phases as shown in FIG. 1. The required model must contain up to six sets of mass transfer rate equations and three sets of equilibrium equations, one for each possible interface, should be also included in the model. Therefore, at present time, actual experimental data is still required to modify and improve the performance of the predictive models for three-phase distillation process.

In three-phase distillation, the column with advanced designed trays is more preferred than the packed column for better handling the two liquid phases. To improve the performance of three-phase distillation in a trayed column, the recent tray assembly design was focused on improving the contact of the three phases shown in FIG. 1, to promote the mixing between Liquid Phase (I) and Liquid Phase (II) uniformly across the trays to avoid “stagnant area”, where one of the phase (most likely the light phase) tends to accumulate. A sudden flashing of the accumulated phase can disrupt of the column operation and in the extreme condition it can cause damage to the column internals.

One of the notable improvements in tray assembly design for handling two liquid phases was disclosed in U.S. Pat. No. 6,588,736 to Chuang, et al., which included a perforated sheet and elongated cover strips arching over the perforations in the sheet. The cover strips have slots with liquid conveying strips in them for conveying liquid along the slots while mixing gas therewith. This reduced stagnant areas downstream of the cover strips, thus reducing the possibility of accumulating the liquid phases and increasing the gas/liquid mixing on the trays. A further slot, extending in the opposite direction to the one above, may be provided in the cover strip and have a conveying strip for conveying liquid mixed with gas to the other end of the cover strip and further reducing the formation of stagnant areas. Another improved tray assembly design was disclosed in U.S. Pat. No. 6,371,455 to Lee, et al. This invention may apply to a single, two or four pass gas/liquid contacting trays.

Retrofitting or revamping idled existing columns for new services, such as conventional distillation, extractive distillation, and azeotropic distillation is very common in the refining and chemical industries. The existing column for retrofitting can be any distillation column, liquid-liquid extractor, extractive stripping column, extractive distillation column, azeotropic distillation column, gas absorption column, or gas stripping column in its original service, equipped with trays or packings. When there are not enough separating trays or packings in the existing column for the revamped (new) service, two or more columns can be connected in series tied with separated vapor and liquid transfer lines.

However, connecting two or more columns for a revamped three-phase distillation column, including extractive distillation column, azeotropic distillation column, etc., can be very difficult or even disastrous if proper design is not taken into consideration. Normally, a vapor transfer line transfers the vapor phase from the top of the lower column to the bottom of the upper column; a separate liquid transfer line transfers the liquid phase from the bottom of the upper column to the top of the lower column.

In the case of three-phase distillation, the two liquid phases definitely separate at the bottom of the upper column, wherein a significant amount of liquid is maintained in order to provide the hydraulic head of the liquid transfer pump for transferring the liquid phases from the bottom of the upper column to the top of the lower column. Under this situation, the liquid transfer pump only withdraws the lower liquid phase (the heavier phase), leaving the light phase to continuously accumulate in the bottom of the upper column. For three-phase extractive distillation column, the light liquid phase (the hydrocarbon phase) has significantly lower boiling point than the heavy liquid phase (the solvent phase). A sudden flashing of the accumulated light liquid phase can disrupt of the column operations and in the extreme condition it can cause damage to the column internals.

U.S. Pat. No. 6,375,802 to Gentry, et al. claimed a method for retrofitting existing aromatics recovery equipment of the sulfolane process by converting an existing liquid-liquid extractor into a vapor-liquid contacting device as the upper portion of an extractive distillation column; and converting an existing extractive stripper into the column as lower portion of the extractive distillation column for recovering aromatics products. The invention did not claim any change in solvent, so the original extraction solvent, sulfolane/water was still used for the retrofitted extractive distillation column. As mentioned earlier, due to very limited solubility of the non-aromatics in sulfolane, U.S. Pat. No. 4,053,369 to Cines clearly mentioned that two liquid phases exist at least in the upper portion of the extractive distillation column, using sulfolane/water as the solvent for aromatics recovery. Obviously the inventors of U.S. Pat. No. 6,375,802 failed to recognize the phase separation problem of two liquid phases at the bottom of liquid-liquid extractor, when it is retrofitted as the upper portion of an extractive distillation column.

Since the current simulation models for three-phase distillation have very limited capability to predict the location and the extent of the two-liquid phase region in the column, methods have to be developed to prevent unexpected phase accumulation in the bottom of the upper column, and to properly transfer the liquid phases from the bottom of the upper column to the top of the lower column of a three-phase extractive distillation column.

One of the objectives of this invention is provide the methods for proper connection of the upper column with the lower column of a revamped three-phase distillation process, including three-phase extractive distillation process for aromatics recovery using sulfolane/water as the extractive solvent, wherein two liquid phases exist at least in the upper column of the process.

### SUMMARY OF THE INVENTION

One aspect of the present invention is a method for connecting multiple existing columns as different portions of a three-phase distillation column, having a vapor phase, a first liquid phase and a second liquid phase for three-phase distillation operations, comprising transferring the vapor phase from a top portion of a lower column to a bottom portion of an upper column, above a bottom liquid level, of the three-phase distillation column through a vapor line, feeding the first and second liquid phases from a bottom portion of an upper column to the top portion of the lower column of the three-phase distillation through a liquid line; and preventing phase separation of the two liquid phases during accumulation without mixing by installing a mixing apparatus at the bottom portion of the upper column. In one aspect, the existing columns may be selected from a conventional distillation column, a liquid-liquid extractor, an extractive stripping column, an extractive distillation column, an azeotropic distillation column, a gas adsorption column, a stripping column, and any combinations thereof. In another aspect, the existing columns are retrofitted into vapor-liquid contacting devices with trays or packings suitable for the three-phase distillation operations.

In yet another embodiment of the invention, the three-phase distillation process includes an extractive distillation column and an azeotropic distillation column. The process is a three-phase extractive distillation column for C₆ to C₈ aromatics recovery. A first lean solvent is fed to a first entry point near a top portion of the three-phase extractive distillation column below an overhead reflux entry point and a hydrocarbon feed is fed to a middle portion of the three-phase extractive distillation column. The first lean solvent is selected from the group consisting of sulfolane, a sulfolane with water as a co-solvent, tetraethylene glycol (TTEG), a TTEG with water as co-solvent, a sulfolane and TTEG mixture, a sulfolane and TTEG mixture with water as co-solvent, triethylene glycol (TEG), a TEG with water as co-solvent, and a sulfolane and TEG mixture, a sulfolane and TEG mixture with water as co-solvent, and any combinations thereof. In one aspect, the first lean solvent is sulfolane with water as the co-solvent.

In another aspect of the invention, the method is further comprising injecting liquid into the bottom portion of the upper column of the three-phase extractive distillation column to prevent or break up of a phase separation of the two liquid phases through any suitable mixing devices. The mixing devices is at least one jet mixer with angled or vertical nozzles or alternatively, the mixing device is a jet mixer with one angled nozzle. In one aspect, the angle of the jet nozzle is 20° to 70° from the bottom base.

Jetting liquid from the jet nozzle is the same liquid withdrawn from the bottom portion of the upper column of the three-phase extractive distillation column, which is recycled through a jet mixer back to the bottom portion of the upper column. The jetting liquid for the jet mixer is an extractive solvent fed to the extractive distillation column or a second extractive solvent feed fed into a second solvent entry point to the extractive distillation column. Both the first and second extractive solvent feeds are sulfolane with water as the co-solvent.

Another aspect of the present invention is a method for connecting multiple existing columns as different portions of a three-phase distillation column, having a vapor phase, a first liquid phase and a second liquid phase for three-phase distillation operations, comprising connecting a vapor line to transfer the vapor phase from a top portion of a lower column to a bottom portion of an upper column, below a liquid level in the bottom portion of the upper column, of the three-phase distillation column; and transferring a liquid phase from the bottom portion of the upper column to a top portion of the lower column of the three-phase distillation through a liquid line.

In one aspect, a mixing apparatus at the bottom portion of the upper column is installed to prevent phase separation wherein the two liquid phases are accumulated without mixing. The mixing apparatus at the bottom portion of the upper column is installed and the same liquid withdrawn from the bottom portion of the upper column of the three-phase extractive distillation column is used as the jetting liquid, which is recycled through a jet mixer back to the bottom portion of the upper column. In another aspect, the mixing apparatus at the bottom portion of the upper column is installed and the jetting liquid for the jet mixer is the extractive solvent fed to the extractive distillation column.

In another aspect of the invention, a vapor distribution device is installed wherein the vapor outlet of the distribution device is submerged in the liquid phase in the bottom of the upper column. The vapor distribution device does not need to be installed in another aspect.

The present invention also describes a system for distillation in multiple existing columns in a three-phase distillation column, having a vapor phase, a first liquid phase and a second liquid phase for three-phase distillation operations, comprising a vapor line to transfer the vapor phase from a top portion of a lower column to a bottom portion of an upper column, below a liquid level in the bottom portion of the upper column, of the three-phase distillation column; and a liquid line to transfer a liquid phase from the bottom portion of the upper column to a top portion of the lower column of the three-phase distillation.

In one aspect the bottom portion of the upper column further comprises a mixing apparatus to prevent separation between the first liquid phase and second liquid phase. The mixing apparatus at the bottom portion of the upper column is installed and the same liquid withdrawn from the bottom portion of the upper column of the three-phase extractive distillation column is used as the jetting liquid, which is recycled through a jet mixer back to the bottom portion of the upper column.

Further, the system and methods of the invention are useful not only for retrofitting existing columns to either recover aromatics in a three-phase distillation but also useful in distillation systems where liquid-liquid interaction occurs. In a preferred embodiment, is the feeding of the ascending vapor from the top of the lower column to below the liquid level in the bottom of the upper column as the aeration/mixing driving force and/or in combination of the installation of a jet mixer to prevent phase separation, which is deemed to occur at the bottom of the upper column, wherein a bulk quantity of liquid is maintained without mixing in order to provide the hydraulic head for the bottom liquid transfer pump.

### BRIEF DESCRIPTION OF THE DRAWINGS

FIG. 1 is a schematic flow chart showing equilibrium and mass transfer relationship of (vapor-liquid-liquid) three-phase equilibrium.

FIG. 2 shows the schematic diagrams of the angled jet mixer and the vertical jet mixer.

FIG. 3 is a schematic flow sheet of connecting two retrofitted columns as the upper and the lower columns of a three-phase extractive distillation column (EDC), wherein a portion of the bottom liquid of the upper column is recycled and used as the jetting liquid of the jet mixer while the vapor from the top of the lower column is fed to above the liquid level in the bottom of the upper column.

FIG. 3A is a schematic flow sheet of connecting two retrofitted columns as the upper and the lower columns of a three-phase extractive distillation column (EDC), wherein a portion of the bottom liquid of the upper column is recycled and used as the jetting liquid of the jet mixer. In addition, the vapor from the top of the lower column is fed to below the liquid level in the bottom of the upper column.

FIG. 4 is a schematic flow sheet of connecting two retrofitted columns as the upper and the lower columns of a three-phase EDC, wherein the extractive distillation solvent is used as the jetting liquid of the jet mixer while the vapor from the top of the lower column is fed to above the liquid level in the bottom of the upper column.

FIG. 4A is a schematic flow sheet of connecting two retrofitted columns as the upper and the lower columns of a three-phase EDC, wherein the extractive distillation solvent is used as the jetting liquid of the jet mixer. In addition, the vapor from the top of the lower column is fed to below the liquid level in the bottom of the upper column.

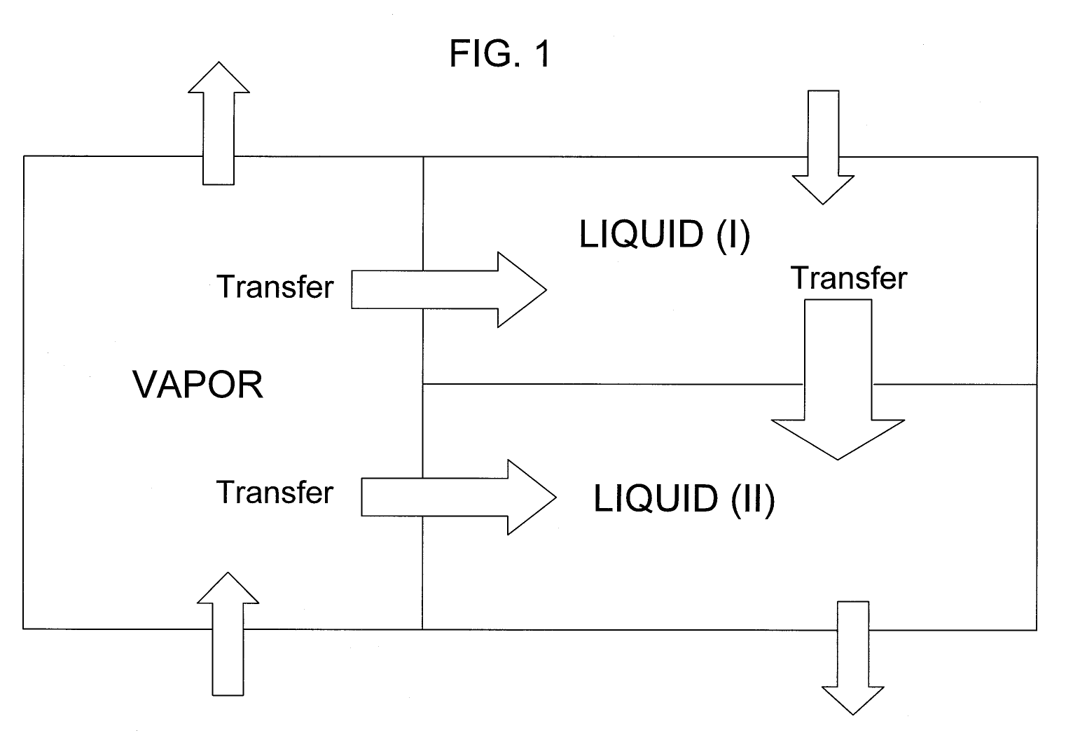

### DETAILED DESCRIPTION OF THE INVENTION

The present invention is related to the methods for connecting multiple existing columns, which are retrofitted into vapor-liquid contacting devices to serve as the different portions of a three-phase (vapor-liquid-liquid) distillation column, including conventional distillation column, extractive distillation column, azeotropic distillation column, stripping column, or others. The existing columns subjected to retrofitting can be any distillation column, liquid-liquid extractor, extractive stripping column, extractive distillation column, azeotropic distillation column, gas absorption column, or gas stripping column in its original service, equipped with trays or packings.

In general, two retrofitted columns are connected to become a single three-phase distillation column by a vapor transfer line to transfer the vapor phase from the top of the lower column to the bottom of the upper column and by a liquid transfer line to transfer the liquid phase from the bottom of the upper column to the top of the lower column. However, as mentioned earlier, two liquid phases tend to separate and the light phase tends to accumulate at the bottom of the upper column, as the heavy phase is continuously withdrawn from the column bottom and transferred through the liquid transfer line to the top the lower column by a liquid transfer pump.

One aspect of the invention is to prevent the liquid phase separation by injecting a portion of the liquid, which is withdrawn from the bottom of the upper column, back to the bottom of the upper column via a recycle line at discharge side of the liquid phase transfer pump. The injection nozzles can be installed at multiple locations and at different angles in the column bottom to promote mixing of the two liquid phases. The size, angle, and location of injection nozzles are determined through the model calculations, and experimental investigation if necessary.

In one embodiment, the invention is to provide the methods for connecting two columns, which are retrofitted into vapor-liquid contacting devices to serve as upper and lower columns of a three-phase extractive distillation column, wherein two liquid phases exist at least in the upper column of the extractive distillation column. At the bottom of the upper column, there exists a bulk quantity of two liquid phases without mixing in order to provide the necessary hydraulic head for the bottom liquid transfer pump. To prevent phase separation there, a jet mixer is used to provide the necessary mixing for creating a pseudo-homogeneous liquid phase containing uniform and well-dispersed two liquid phases. Jet mixers have been used in industry to homogenize the content of vessels and large storage tanks, and to mix hazardous materials where mechanical mixing is impractical. In addition, jet mixers have no moving parts inside the vessel and are connected to pumps, which are easier to duplicate and service.

In another aspect, the invention includes the use of the extractive solvent feed to the extractive distillation column as the jetting liquid for the jet mixer, not only to disperse the two liquid phases, but also to help dissolving additional non-aromatics in the light liquid phase (the hydrocarbon phase) thereby minimizing the size of light liquid phase. Diminished light liquid phase alone helps relieving a part of the phase separation problem at the bottom of the upper column.

All or a part of the jetting solvent can be deducted from total solvent feed to the extractive distillation column, so in a sense the extractive distillation process has two solvent feed entry points. The second solvent feed (liquid for the jet mixer) entry point at the bottom of the upper column is either above or below the hydrocarbon feed entry point. Nevertheless, the normal solvent feed to the extractive distillation column can remain the same, even if additional solvent is fed to the column through the jet mixer as the jetting liquid.

One other aspect of the invention is to prevent the liquid phase separation by submerging the vapor line connecting the top of the lower column of the extractive distillation column to below the operating liquid level in the bottom of the upper column—with or without a vapor distribution device inside the bottom of the upper column. The submergence of the vapor inlet from the top of the lower column into the liquid phase not only promotes aeration and mixing of the Liquid Phase (I) and Liquid Phase (II) in the bottom of the column which prevents the formation of two liquid phases and causes the operation problems as outlined above, but also provide additional mass transfer actions among the vapor, liquid I and liquid II phases which further increase the overall mass transfer theoretical stages for the extractive distillation.

The embodiments described in this present invention are directed to the methods for connecting two columns, which are retrofitted into vapor-liquid contacting devices to become, respectively, the upper column and the lower column of a three-phase extractive distillation column, where two liquid phases exist at least in the upper column of the extractive distillation column. The vapor phase in the column is transferred from the top of the lower column to the bottom of the upper column by a vapor transfer line; the liquid phase is transferred from the bottom of the upper column to the top of the lower column by a liquid transfer line. In order to provide the hydraulic head for the liquid phase transfer pump, a significant liquid level is maintained in the bottom of the upper column, causing the two liquid phases to separate into the light and heavy phases. The ratio of the bottom liquid level to the column diameter is typically 2:3, changing slightly depending upon the hydraulic head required for the liquid phase transfer pump. For example, a commercial column with 3-meter diameter, the liquid level can be as much as 2 meters with 14 cubic meters liquid accumulation at the bottom of the upper column. In this case, the liquid phase transfer pump withdraws only the heavy phase, leaving the light phase to accumulate in the bottom of the upper column. A sudden flashing of the accumulated light phase can disrupt of the column operations and in the extreme condition it could cause damage to the column internals.

### Jet Mixers for Mixing the Two Liquid Phases

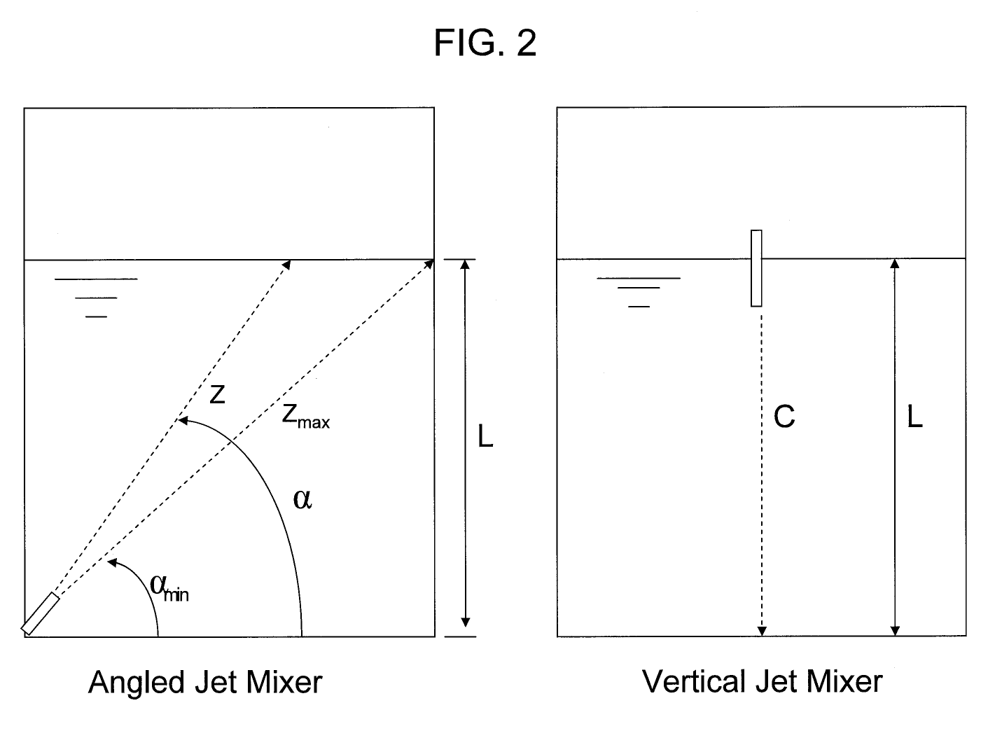

In a further aspect of the present invention, a jet mixer is used to prevent phase separation at the bottom of the upper column, creating a pseudo-homogeneous liquid phase containing well-dispersed two liquid phases. In general, the mixing efficiency of a jet mixer is maximized when the flow entrained by the jet is maximized, where the entrained flow is proportional to the path length (Refer to article: Albertson, M., Dai, Y., Jensen, R., Rouse, H., “Diffusion of Submerged Jets,” Am. Soc. Civil Eng. Transactions, Paper No. 2409, 640-697 (1948)). As shown in FIG. 2, there are two common types of jet mixers depending on the angle and the location of the jet nozzles. The angled jet mixer has a nozzle submerged at the bottom corner of the liquid and points upward.

### Process Liquid as the Jet Mixer Liquid

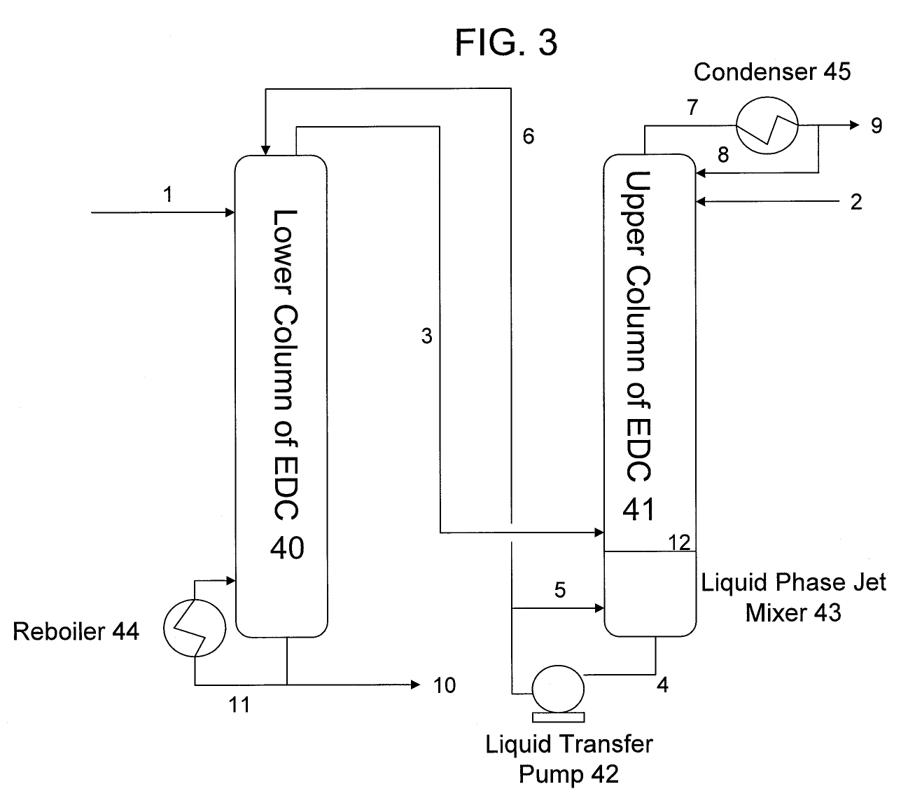

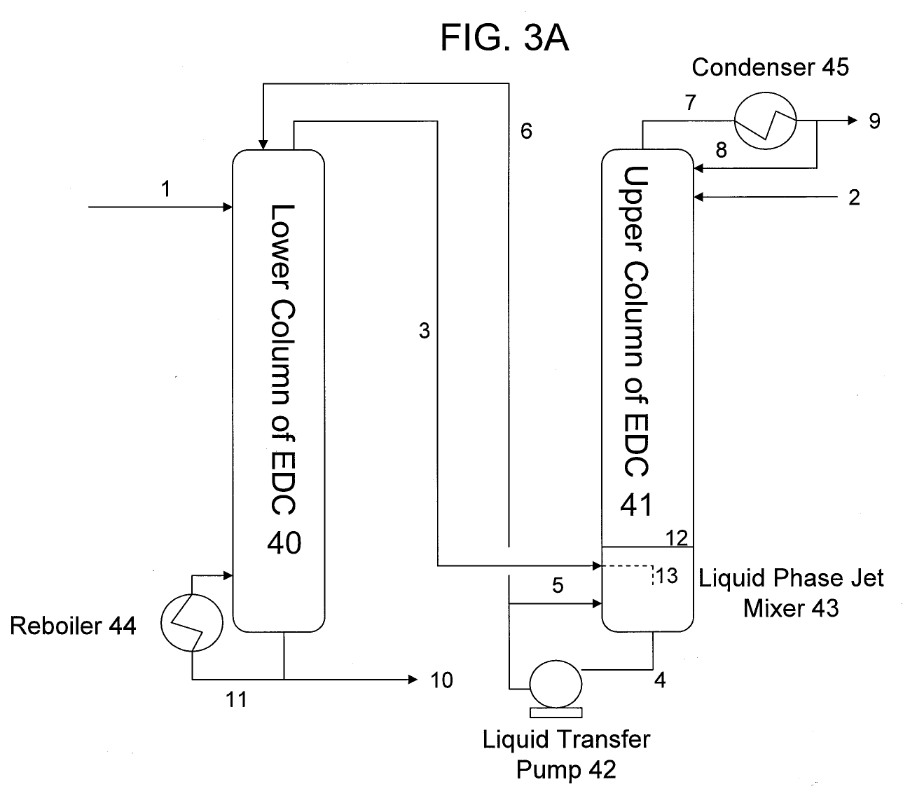

FIG. 3 illustrates one of the embodiments of the invention in which two columns with suitable diameter and height are retrofitted into vapor-liquid contacting devices. The original service of these columns can be conventional distillation, liquid-liquid extraction, extractive distillation, azeotropic distillation, absorption, adsorption, stripping, or the combinations thereof. One column becomes the upper column and the other becomes the lower column of a three-phase extractive distillation column for aromatics recovery, where two liquid phases exist at least in the upper column of the extractive distillation column.

The feed containing C₆ to C₈ hydrocarbons with 20 to 95 wt % aromatics, preferably 30 to 85 wt % aromatics, is fed to near the top of the Lower Column 40 via Line 1. Temperature of the hydrocarbon feed is maintained at approximately the bubble point. The lean solvent is introduced via Line 2 to near the top of the Upper Column 41. In order to generate an internal reflux within Column 41, the temperature of the lean extractive solvent is controlled with a heat exchanger (not shown) to be a few degrees lower than that of Column 41 at the corresponding entry point. The flow rate of solvent stream 2 is maintained so that the solvent-to-hydrocarbon feed weight ratio ranges from approximately 0.5:1 to 20:1 and preferably from 1:1 to 10:1. Suitable extractive solvents include, sulfolane, a sulfolane with water as co-solvent, tetraethylene glycol (TTEG), a TTEG with water as co-solvent, a sulfolane and TTEG mixture, a sulfolane and TTEG mixture with water as co-solvent, triethylene glycol (TEG), and a TEG with water as co-solvent, a sulfolane and TEG mixture, a sulfolane and TEG mixture with water as co-solvent, and the combinations thereof. All these solvents have limited solubility for non-aromatic hydrocarbons and tend to create two liquid phases in the upper portion (e.g., Upper Column 41) of the three-phase extractive distillation column for aromatics recovery.

A portion of overhead stream in Line 7 is recycled back to the top of Column 41 as reflux (after condensed by Condenser 45) via Line 8 to quench entrained solvents in the rising vapor stream. Raffinate product containing mainly non-aromatic hydrocarbons is produced in the overhead of Column 41 through Line 9. The vapor flow within Columns 40 and 41 is generated by Reboiler 44, which is heated by steam or hot oil at a rate that is sufficient to control the column bottom temperature and the overhead stream composition and flow rate. The reboiler temperature typically ranges from 60 to 250° C. and preferably from 80 to 200° C. The pressure within Columns 40 and 41 typically ranges from 0 to 8 atmospheres (atm) (absolute) and preferably from 0 to 5 atm (absolute).

The vapor phase in the column is transferred via Line 3 from the top of the Lower Column 40 to the bottom of the Upper Column 41; the liquid phase is transferred via Lines 4 and 6 from the bottom of the Upper Column 41 to the top of Lower Column 40 by a Liquid Transfer Pump 42. As mentioned earlier, in order to provide the hydraulic head for Pump 42, a significant liquid level is maintained in the bottom of the upper column, causing the two liquid phases to separate into the light and heavy phases.

To prevent the phase separation, Liquid Phase Jet Mixer 43 is installed at the bottom of Column 41, using one or multiple angled nozzles or vertical nozzles, or the combinations thereof to provide the liquid mixing, preferably using one angled nozzle. Estimated by Equation 1, angle of the angled nozzle is in the range of 10 to 70°, preferably in the range of 30 to 70°. The liquid height in the bottom of Column 41 should be less than the column diameter, preferably ratio of liquid height (L) and column diameter (D) is in the range of 0.5:1 to 0.75:1. The jet liquid for the nozzle is taken from Line 5, a split stream from Line 6 at the discharge side of Pump 42. Jet velocity and jet flow rate are, respectively, estimated by Equations 5 and 6.

The rich solvent containing sulfolane, aromatic hydrocarbons and a small quantity of water is withdrawn from the bottom of the Lower Column 40, and transferred to a solvent recovery column (not shown), where the purified aromatic hydrocarbons are produced from the overhead stream and the lean solvent is recovered from the bottom stream for recycling to the top of Column 41 through Line 2. To help stripping the aromatic hydrocarbons from the rich solvent in the solvent recovery column, the column pressure can be reduced, and steam or non-condensable gases can be used as the media to assist stripping.

### Extractive Solvent as the Jet Mixer Liquid

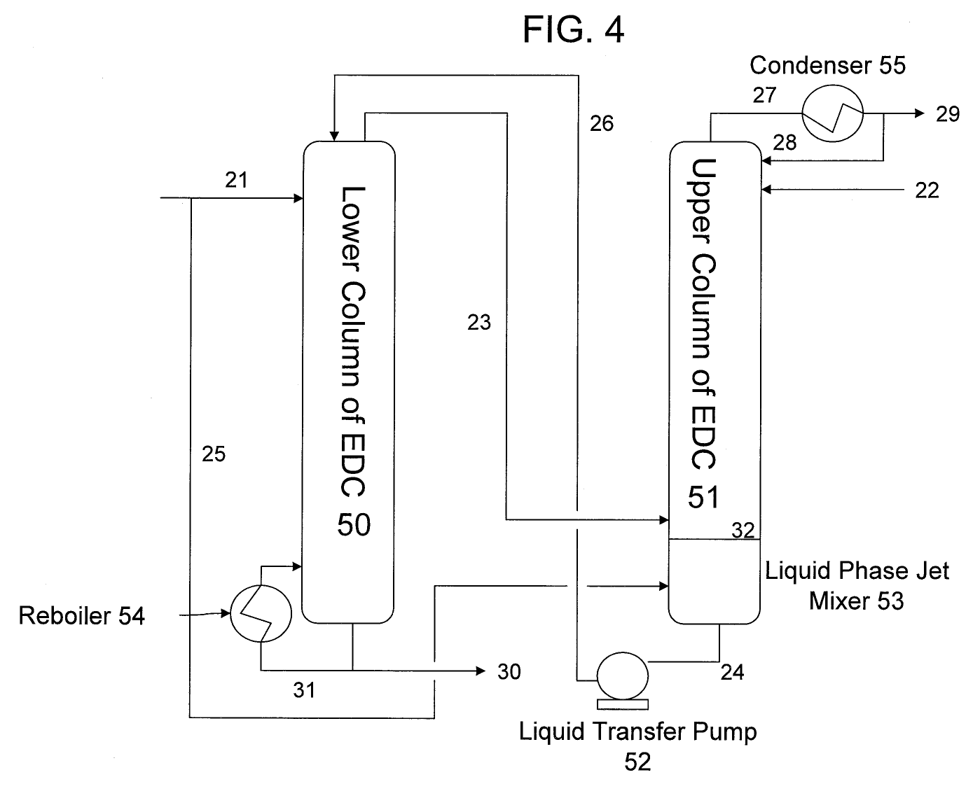

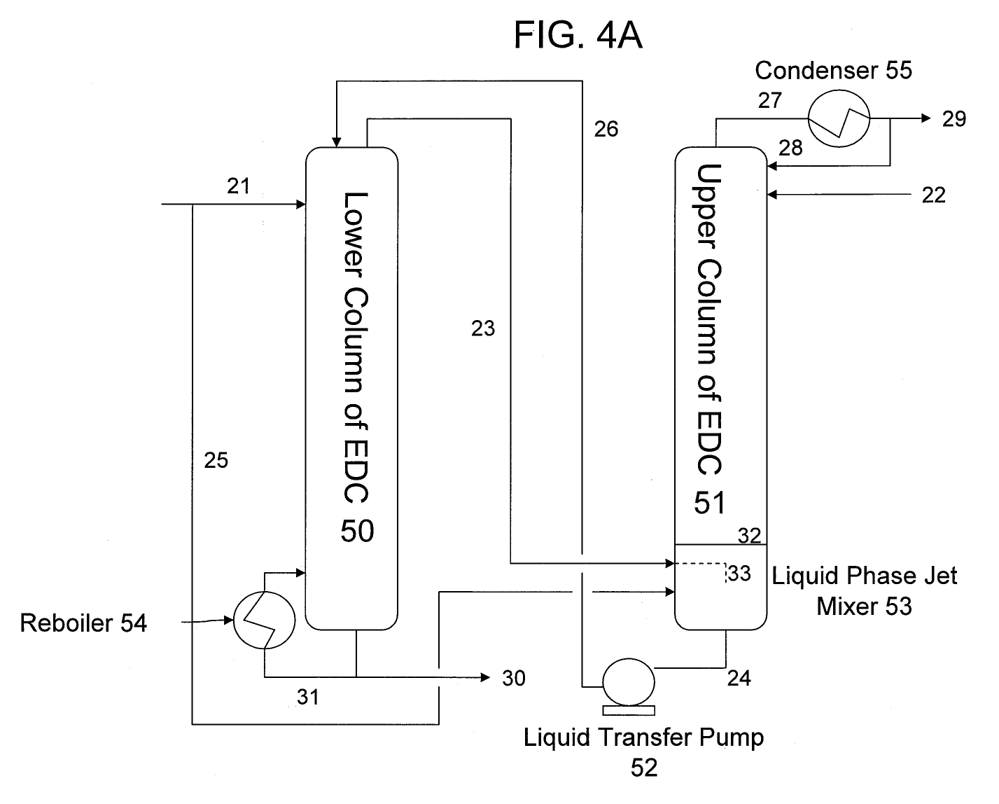

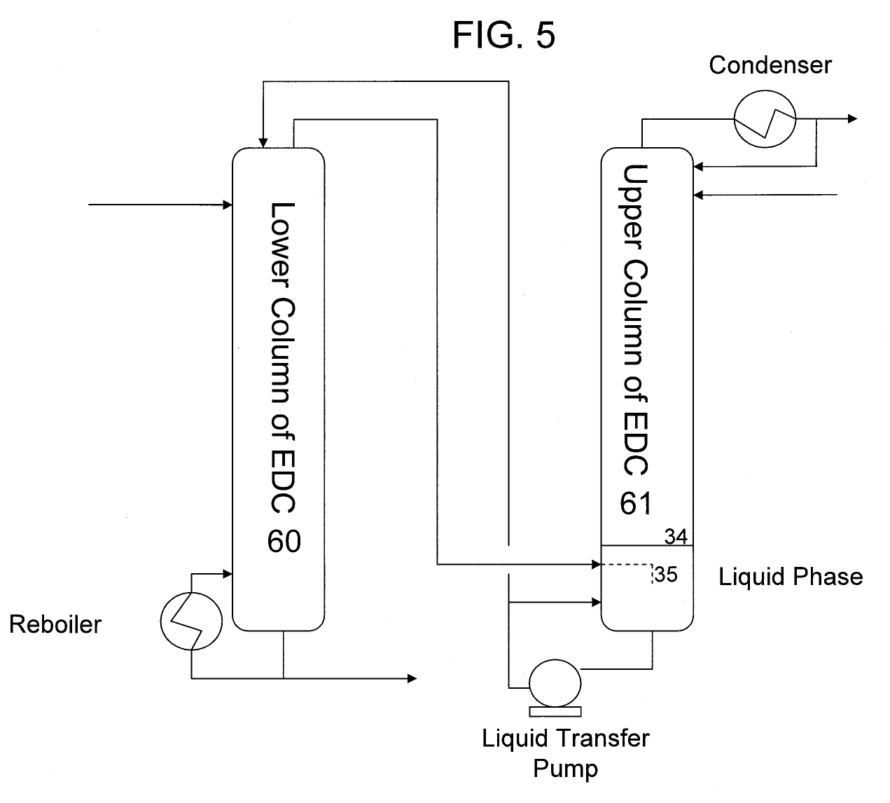

FIG. 4 illustrates another aspect of the invention in which, again, two columns with suitable diameter and height are retrofitted into vapor-liquid contacting devices. The original service of these columns can be conventional distillation, liquid-liquid extraction, extractive distillation, azeotropic distillation, absorption, adsorption, stripping, or the combinations thereof. One column becomes the upper column and the other becomes the lower column of a three-phase extractive distillation column for aromatics recovery, where two liquid phases exist at least in the upper portion of the extractive distillation column.

The process description and operating condition related to each unit in FIG. 3 are essentially applicable to the process units in FIG. 4. However, instead of using the liquid from the bottom of the Upper Column 51, the extractive solvent feed from Line 25, a split stream from the solvent feed stream (Line 21), is used as the jetting liquid for the Liquid Phase Jet Mixer 53 at the bottom of Upper Column 51. In addition to dispersing the two liquid phases, using the extractive solvent as the jetting liquid can help to reduce the size of the light liquid phase by dissolving some of the non-aromatic hydrocarbons in that phase to partially relief the phase separation problem. Furthermore, it also provides a second lean solvent feed to the mid-location of the extractive distillation column as an option to improve the performance of the extractive distillation process.

Again, suitable extractive solvents include, sulfolane, a sulfolane with water as co-solvent, tetraethylene glycol (TTEG), a TTEG with water as co-solvent, a sulfolane and TTEG mixture, a sulfolane and TTEG mixture with water as co-solvent, triethylene glycol (TEG), and a TEG with water as co-solvent, a sulfolane and TEG mixture, a sulfolane and TEG mixture with water as co-solvent, and the combinations thereof. One example of an ideal solvent is sulfolane with water as the co-solvent, where the water content in sulfolane typically ranges from 0.01 to 10% and preferably from 0.1 to 3%. All these solvents have limited solubility for non-aromatic hydrocarbons and tend to create two liquid phases in the upper portion (e.g., Upper Column 51) of the three-phase extractive distillation column for aromatics recovery.

### Lower Column Vapor for Aerating and Mixing the Two Liquid Phases

FIGS. 3A, 4A and 5 illustrate another preferred embodiment of the invention in which, again, two columns with suitable diameter and height are retrofitted into vapor-liquid contacting devices. The original service of these columns can be conventional distillation, liquid-liquid extraction, extractive distillation, azeotropic distillation, absorption, adsorption, stripping, or the combinations thereof. One column becomes the upper column and the other becomes the lower column of a three-phase extractive distillation column for aromatics recovery, where two liquid phases exist at least in the upper portion of the extractive distillation column.

The process description and operating condition related to each unit in FIGS. 3 and 4 are essentially applicable to the process units in FIGS. 3A and 4A, respectively. However, instead of feeding the vapor from top of the Lower Column 40 (or 50) to above the bottom liquid level 12 (or 32), the vapor is fed to below the liquid level, with, or without, a vapor distribution device 13 (or 33).

FIG. 5 illustrates yet another embodiment of the present invention in which, again, two columns with suitable diameter and height are retrofitted into vapor-liquid contacting devices. The original service of these columns can be conventional distillation, liquid-liquid extraction, extractive distillation, azeotropic distillation, absorption, adsorption, stripping, or the combinations thereof. One column becomes the upper column and the other becomes the lower column of a three-phase extractive distillation column for aromatics recovery, where two liquid phases exist at least in the upper portion of the extractive distillation column. In this arrangement, however, there will be no Jet Mixer installed at the bottom of the Upper Column and only Vapor from the top of the Lower Column 60 to be fed to below the bottom liquid level 34, with, or without, a vapor distribution device 35.

### EXAMPLES

### Example 1

This example demonstrates that two liquid phases do exist when sulfolane is used as the extractive distillation solvent for aromatics and non-aromatics separation. To a hydrocarbon mixture of aromatic and non-aromatic hydrocarbons, sulfolane was added as an extractive solvent at various solvent-to-feed weight ratios. The mixture (including the extractive solvent) was then transferred to a round bottom flask equipped with a total reflux condenser, which represented one theoretical stage in an extractive distillation column. The flask was submerged in a constant temperature bath controlled within 0.1° C. and the mixture in the flask was well mixed with a magnetic bar. The mixture was heated under total reflux to its boiling points for 30 minutes to establish the vapor-liquid equilibrium for the mixture. Then the mixing was stopped and the number of liquid phases in the liquid mixture under this condition was observed and recorded. Test results are summarized in Table 1.

TABLE 1

| Liquid Composition (wt. %) | Solvent-to-Feed Ratio | Liquid Phases |
|---|---|---|
| 50% n-C₇/50% Toluene | 1.0 | 2 |
| | 3.0 | 2 |
| | 5.0 | 2 |
| | 5.0 | 2* |
| 50% n-C₇/50% Benzene | 1.0 | 2 |
| | 3.0 | 2 |
| | 5.0 | 2 |

*Sufolane with 1.0 wt % water as the co-solvent

Table 1 shows that, under various feed compositions and the solvent-to-feed weight ratio as high as 5:1, two liquid phases do exist when sulfolane, which has limited solubility for non-aromatics (such as n-heptane), is used as the extractive distillation solvent.

### Example 2

This example demonstrates that two liquid phases do exist when tetraethylene glycol is used as the extractive distillation solvent for aromatics and non-aromatics separation. To a hydrocarbon mixture of 50 wt % toluene and 50 wt % n-heptane, tetraethylene glycol was added as an extractive solvent at various solvent-to-feed weight ratios to determine the number of liquid phases under the equilibrium condition at boiling point of the mixtures. Experimental procedure is described in Example 1. Test results are summarized in Table 2.

TABLE 2
Hydrocarbon Feed Composition: 50 wt % n-Heptane and
50 wt % Toluene

| Solvent-to-Feed Ratio | Liquid Phases |
|---|---|
| 1.0 | 2 |
| 3.0 | 2 |
| 5.0 | 2 |
| 7.0 | 2 |
| 9.0 | 2 |

Again, it shows two liquid phases do exist when tetraethylene glycol is used as the extractive distillation solvent, even with solvent-to-hydrocarbon feed ratio as high as 9:1.

Having now fully described the invention, the foregoing has described the principles, various embodiments and modes of operation of the present invention. However, the invention should not be construed as limited to the particular embodiments discussed. Instead, the above-described embodiments should be regarded as illustrative rather than restrictive, and it should be appreciated that variations may be made in those embodiments by workers skilled in the art without departing from the scope of present invention as defined by the following claims.

What is claimed is:

1. A method for connecting multiple existing columns as different portions of a three-phase distillation column, having a vapor phase, a first liquid phase and a second liquid phase for three-phase distillation operations, comprising:
(a) transferring the vapor phase from a top portion of a lower column to a bottom portion of an upper column, above a bottom liquid level, of the three-phase distillation column through a vapor line;
(b) feeding the first and second liquid phases from a bottom portion of an upper column to the top portion of the lower column of the three-phase distillation through a liquid line; and
(c) preventing phase separation of the two liquid phases during accumulation without mixing by installing a mixing apparatus at the bottom portion of the upper column.

2. A method according to claim 1, wherein the existing columns may be selected from a conventional distillation column, a liquid-liquid extractor, an extractive stripping column, an extractive distillation column, an azeotropic distillation column, a gas adsorption column, a stripping column, and any combinations thereof.

3. A method according to claim 1, wherein the existing columns are retrofitted into vapor-liquid contacting devices with trays or packings suitable for the three-phase distillation operations.

4. A method according to claim 1, wherein the three-phase distillation process includes an extractive distillation column and an azeotropic distillation column.

5. A method according to claim 4, wherein the process is a three-phase extractive distillation column for C₆ to C₈ aromatics recovery.

6. A method according to claim 5, wherein a first lean solvent is fed to a first entry point near a top portion of the three-phase extractive distillation column below an overhead reflux entry point and a hydrocarbon feed is fed to a middle portion of the three-phase extractive distillation column.

7. A method according to claim 6, wherein the first lean solvent is selected from the group consisting of sulfolane, a sulfolane with water as a co-solvent, tetraethylene glycol (TTEG), a TTEG with water as co-solvent, a sulfolane and TTEG mixture, a sulfolane and TTEG mixture with water as co-solvent, triethylene glycol (TEG), a TEG with water as co-solvent, and a sulfolane and TEG mixture, a sulfolane and TEG mixture with water as co-solvent, and any combinations thereof.

8. A method according to claim 7, wherein the first lean solvent is sulfolane with water as the co-solvent.

9. A method according to claim 1, further comprising injecting liquid into the bottom portion of the upper column of the three-phase extractive distillation column to prevent or break up of a phase separation of the two liquid phases through any suitable mixing devices.

10. A method according to claim 9, wherein the mixing devices is at least one jet mixer with angled or vertical nozzles.

11. A method according to claim 9, wherein the mixing device is a jet mixer with one angled nozzle.

12. A method according to claim 11, wherein the angle of the jet nozzle is 20 to 70° from the bottom base.

13. A method according to claim 11, wherein jetting liquid from the jet nozzle is the same liquid withdrawn from the bottom portion of the upper column of the three-phase extractive distillation column, which is recycled through a jet mixer back to the bottom portion of the upper column.

14. A method according to claim 11, wherein jetting liquid for the jet mixer is an extractive solvent fed to the extractive distillation column.

15. A method according to claim 14, the jetting liquid for the jet mixer is a second extractive solvent feed fed into a second solvent entry point to the extractive distillation column.

16. A method according to claim 15, wherein both the first and second extractive solvent feeds are sulfolane with water as the co-solvent.

17. A method for connecting multiple existing columns as different portions of a three-phase distillation column, having a vapor phase, a first liquid phase and a second liquid phase for three-phase distillation operations, comprising:
(a) connecting a vapor line to transfer the vapor phase from a top portion of a lower column to a bottom portion of an upper column, below a liquid level in the bottom portion of the upper column, of the three-phase distillation column; and
(b) transferring a liquid phase from the bottom portion of the upper column to a top portion of the lower column of the three-phase distillation through a liquid line.

18. A method according to claim 17, wherein a mixing apparatus at the bottom portion of the upper column is installed to prevent phase separation wherein the two liquid phases are accumulated without mixing.

19. A method according to claim 17, wherein a mixing apparatus at the bottom portion of the upper column is installed and the same liquid withdrawn from the bottom portion of the upper column of the three-phase extractive distillation column is used as the jetting liquid, which is recycled through a jet mixer back to the bottom portion of the upper column.

20. A method according to claim 19, wherein a mixing apparatus at the bottom portion of the upper column is installed and the jetting liquid for the jet mixer is the extractive solvent fed to the extractive distillation column.

21. A method according to claim 17, wherein a vapor distribution device is installed wherein the vapor outlet of the distribution device is submerged in the liquid phase in the bottom of the upper column.

22. A method according to claim 17, wherein a vapor distribution device is not installed.

23. A system for distillation in multiple existing columns in a three-phase distillation column, having a vapor phase, a first liquid phase and a second liquid phase for three-phase distillation operations, comprising:
a vapor line to transfer the vapor phase from a top portion of a lower column to a bottom portion of an upper column, below a liquid level in the bottom portion of the upper column, of the three-phase distillation column; and
a liquid line to transfer a liquid phase from the bottom portion of the upper column to a top portion of the lower column of the three-phase distillation.

24. The system according to claim 23, wherein the bottom portion of the upper column further comprises a mixing apparatus to prevent separation between the first liquid phase and second liquid phase.

25. The system according to claim 24, wherein the mixing apparatus at the bottom portion of the upper column is installed and the same liquid withdrawn from the bottom portion of the upper column of the three-phase extractive distillation column is used as the jetting liquid, which is recycled through a jet mixer back to the bottom portion of the upper column.
